(19) United States
(12) Patent Application Publication
(10) Pub. No.: US 2025/0162365 A1
(43) Pub. Date: May 22, 2025

(54) SPRING ISOLATOR PAD WITH INTEGRATED SPRING ROTATION STOP AND PAD ROTATION STOP

(71) Applicant: Ford Global Technologies, LLC, Dearborn, MI (US)

(72) Inventors: Zachary Scott Wiedyke, Trenton, MI (US); Rafi Alamgir, Lasalle (CA)

(21) Appl. No.: 18/515,573

(22) Filed: Nov. 21, 2023

(51) Int. Cl. B60G 7/00

(52) U.S. Cl. CPC B60G 7/001; B60G 2202/12; B60G 2202/20; B60G 2204/143

(57) ABSTRACT

A spring isolator pad for a suspension assembly for a vehicle may be provided. The spring isolator pad may include a rubber isolator pad for supporting a coil spring operably coupled to a control arm, and a structural insert for supporting a coil spring and the rubber isolator pad. The rubber isolator pad may be operably coupled to the structural insert and comprises a first plurality of extensions. The structural insert may include a second plurality of extensions and a base. The control arm may include a spring link with an orifice. The structural insert may engage with the rubber isolator pad and the spring link to limit rotation of the coil spring relative to the control arm responsive to compression cycles via the first plurality of extensions and the second plurality of extensions.

### TECHNICAL FIELD

Example embodiments generally relate to suspension components and, more particularly, relate to a spring isolator pad for limiting a coil spring and coil spring support elements of a strut of a vehicle.

### BACKGROUND

Some vehicles utilize a suspension assembly that has a relative lack of complexity to provide for ease of manufacture. The suspension assembly in these cases may include various suspension components which may include, but not be limited to, a coil spring, control arm, spring link, rubber isolator pad, and spring isolator pad. The spring link, rubber isolator pad, and spring isolator pad may work in conjunction to help prevent rotation of the coil spring relative to the control arm during compression cycles.

To prevent and limit coil spring rotation within a suspension assembly, the rubber isolator pad has typically been used with the spring link to aim to limit the rotation. However, during operation of a vehicle, the coil spring is put under various changes in load and tension, which may cause a subsystem of the suspension assembly to rotate. Rotation of the coil spring may result in reduced performance. Therefore, there may be a need to add further support to the rubber isolator pad and the suspension assembly without the addition of new parts that may compromise the efficiency and weight of the suspension assembly and vehicle.

### BRIEF SUMMARY OF SOME EXAMPLES

In accordance with an example embodiment, a spring isolator pad for a suspension assembly for a vehicle may be provided. The spring isolator pad may include a rubber isolator pad for supporting a coil spring operably coupled to a control arm, and a spring isolator pad for supporting a coil spring and the rubber isolator pad. The rubber isolator pad may be operably coupled to the spring isolator pad and comprises a first plurality of extensions. The structural insert may include a second plurality of extensions and a base. The control arm may include a spring link with an orifice. The structural insert may engage with the rubber isolator pad and the spring link to limit rotation of the coil spring relative to the control arm responsive to compression cycles via the first plurality of extensions and the second plurality of extensions.

In another example embodiment, a suspension assembly for a vehicle of an example embodiment may be provided. The suspension assembly may include a coil spring disposed below a chassis of the vehicle, a control arm operably coupled to the coil spring and a wheel of the vehicle, a rubber isolator pad for supporting the coil spring; and a structural insert for supporting the coil spring and rubber isolator pad. The control arm may include a spring link with an orifice. The rubber isolator pad may be disposed on the structural insert and include a first plurality of extensions. The structural insert may include a second plurality of extensions and a base. The structural insert may engage with the rubber isolator pad and the spring link to limit rotation of the coil spring relative to the control arm responsive to compression cycles via the first plurality of extensions and the second plurality of extensions.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 depicts a block diagram of a suspension assembly for a vehicle suspension system in accordance with an example embodiment;

FIG. 2 illustrates a perspective view of a suspension assembly for a vehicle suspension system in accordance with an example embodiment;

FIG. 3 depicts a perspective view of a subsection of the suspension assembly in accordance with an example embodiment;

FIG. 4 illustrates a separated view of the spring isolator pad in accordance with an example embodiment;

FIG. 5 depicts a cross-section side view of the spring isolator pad in accordance with an example embodiment;

FIG. 6 illustrates a perspective view of the structural insert in accordance with an example embodiment;

FIG. 7 depicts a top view of the structural insert in accordance with an example embodiment;

FIG. 8 illustrates a perspective view of the rubber isolator pad in accordance with an example embodiment;

FIG. 9 depicts a side view of the rubber isolator pad in accordance with an example embodiment; and

FIG. 10 illustrates a bottom view of the rubber isolator pad in accordance with an example embodiment;

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein may address the issues described above. In this regard, for example, some embodiments may provide a structural insert for a suspension system of a vehicle that may make the coil spring and the suspension system as a whole, stronger and more efficient. Some embodiments may provide for the structural insert to be a unitary piece enclosed by the rubber isolator pad. As a result, installation of the suspension assembly may require less effort, fewer components, less time and thus may be more efficient.

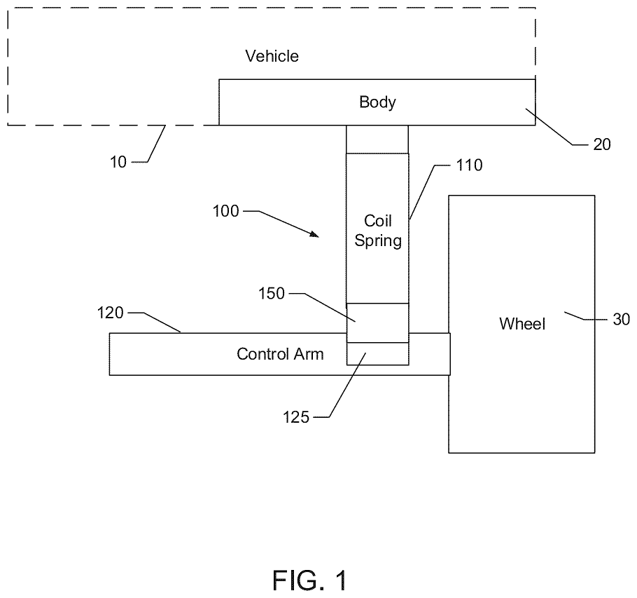

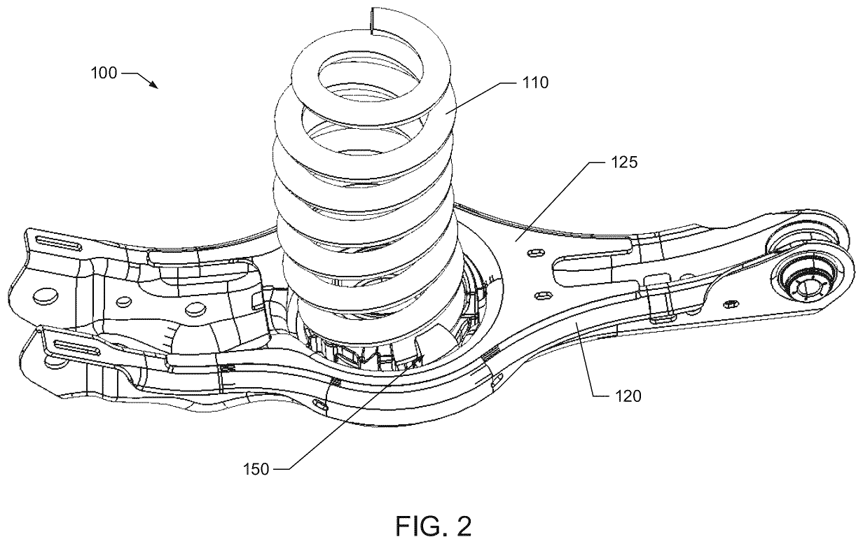

FIG. 1 illustrates a block diagram of the suspension assembly 100 of a vehicle 10 according to an example embodiment, and FIG. 2 illustrates perspective view of a suspension assembly for a vehicle suspension system according to an example embodiment. As seen in FIGS. 1-2, in some embodiments, the suspension assembly 100 may include a coil spring 110, a control arm 120, and a spring isolator pad 150. The spring isolator pad 150 may include a rubber isolator pad 130, and a structural insert 140. The suspension assembly 100 of the vehicle 10 may operably couple to a body 20 and a wheel 30 of a vehicle. In some cases, the vehicle 10 may include a chassis or frame. The chassis or frame may support and may form the foundation structure of the vehicle 10. In an example embodiment, the chassis and frame may be formed of one or more casted subframes, and the coil spring 110 may be operably coupled to the chassis or frame. In some cases, the vehicle may be unibody, where the chassis/frame and body 20 are one element. In some cases, the coil spring 110 may be part of a strut system of the vehicle. In this regard, the coil spring 110 may dampen the articulation of the wheel 30 so that the movement of the wheel 30 may not get translated directly into movement of the body 20. In doing so, the coil spring 110 may increase the quality of the ride as perceived by passengers within the body 20 of the vehicle 10 by absorbing some of the force from bumps due to the articulation of the wheel 30. Additionally, in an example embodiment, the suspension assembly 100 may include a form of a strut construction, and in this regard, the suspension assembly 100 may also play a role in the steering of the vehicle 10. As such, the coil spring 110 may be operably coupled to a control arm 120, and the control arm 120 may act as a steering pivot for the wheel 30. The control arm 120 may be operable coupled to the wheel 30 on one side and chassis, frame, or body 20 on another side. Regardless, in some cases, the coil spring 110 may be substantially helical in shape.

The control arm 120 may also include a spring link 125. The spring link 125 may be disposed within a portion of the control arm 120 body and may serve to operably couple the control arm 120 and the coil spring 110. The spring link 125 may operably couple to the coil spring 110 via the rubber isolator pad 130 and the structural insert 140. The rubber isolator pad 130 and the structural insert 140 may engage the spring link 125 and the coil spring 110 to help operably couple the suspension assembly 100 elements together. Together, the spring link 125, the rubber isolator pad 130, and the structural insert 140 may help limit the rotation of the coil spring 110 via their structure and orientation. The coil spring 110 may tend to rotate clockwise relative to the front of the vehicle 10 when under stress and tension from vehicle 10 operation causing compression of the coil spring 110. In some cases, the coil spring 110 may tend to rotate counter-clockwise under compression. The rotation force of the coil spring 110 may result in forces to be focused on various elements of the suspensions assembly 100. Thus, the support provided and operable coupling of the spring link 125, the rubber isolator pad 130, and the structural insert 140 may help balance the resultant forces transferred by the coil spring 110 and increase suspension assembly 100 durability.

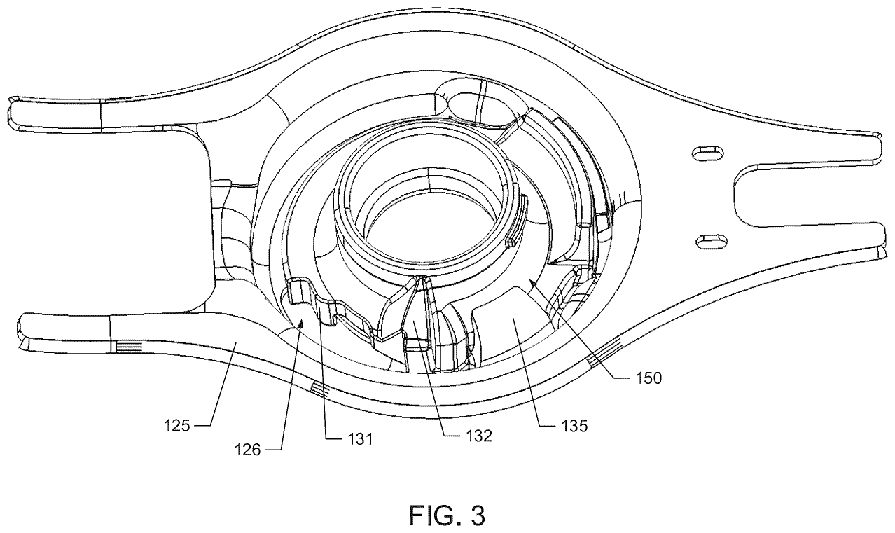

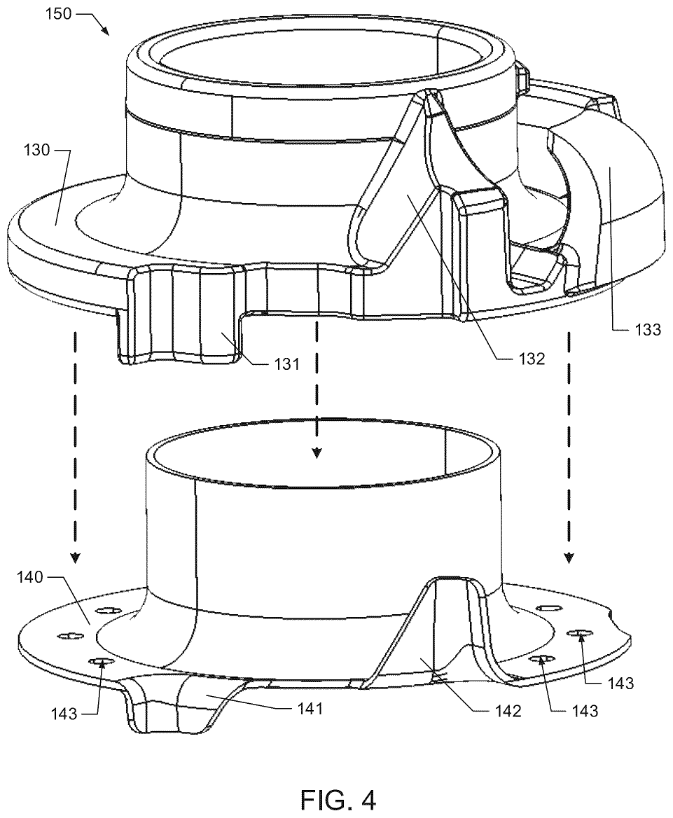

FIG. 3 depicts a perspective view of a portion of the suspension assembly 100 in accordance with an example embodiment, and FIG. 4 illustrates a separated view of the spring isolator pad 150 in accordance with an example embodiment. In this regard, FIG. 3 depicts the engagement between the spring link 125, the rubber isolator pad 130, and the structural insert 140 in accordance with an example embodiment. In some cases, the rubber isolator pad 130 may fully enclose the structural insert 140. In other words, the rubber isolator pad 130 may be a sort of casing or cover for the structural insert 140 that may extend entirely around and enclose the structural insert 140. The structural insert 140 may therefore be an underlying structure that may help support the rubber isolator pad 130 to increase durability of the rubber isolator pad 130 while attempting to limit the coil spring 110 rotation. In this regard, the spring isolator 140 may be formed from a rigid material, such as a metal alloy, in order to have the strength to support the shape of the rubber isolator pad 130 in its operable coupling with the coil spring 110.

As shown in FIG. 4, the structure of the rubber isolator pad 130 and the structural insert 140 may be similar to one another. The rubber isolator pad 130 may include a first plurality of extensions that may engage the coil spring 110 and the spring link 125. The structural insert 140 may have a second plurality of extensions that may engage the coil spring 110 and the spring link 125, as well as engage the first plurality of extensions. The second plurality of extensions of the structural insert 140 may include a first structural insert extension 141 and a second structural insert extension 142. The first structural insert extension 141 may protrude from a base 145 of the structural insert 140 substantially parallel to a longitudinal axis of the coil spring 110 in a first direction away from the coil spring 110. The second structural insert extension 142 may protrude from the base 145 of the structural insert 140 substantially parallel to a longitudinal axis of the coil spring 110 in a second direction towards the coil spring 110. The first rubber isolator pad extension 131 may protrude from the rubber isolator pad 130 in the first direction, and the second rubber isolator pad extension 132 may protrude from the rubber isolator pad 130 in the second direction. In some cases, due to the rubber isolator pad 130 completely enclosing the structural insert 140, the first plurality of extensions and the second plurality of extensions may serve similar functional purposes for limiting the rotation of the coil spring 110 during operation of the vehicle 10.

As shown in FIGS. 2-3, the first structural insert extension 141 and first rubber isolator pad extension 131 may engage an orifice 126 of the spring link 125. The orifice 126 may be a drain hole for clearing water, dust, and debris from the spring link 125 and the suspension assembly 100 as a whole. In some cases, the second structural insert extension 142 and the second rubber isolator pad extension 132 may engage an end of the coil spring 110. As the coil spring 110 may be urged to rotate responsive to compression cycles, the end of the coil spring 110 may push against the second structural insert extension 142 and the second rubber isolator pad extension 132 and may thus exert a force on the rubber isolator pad 130 and the structural insert 140. However, as a result, the first structural insert extension 141 and the first rubber isolator pad extension 131 may operably couple to the orifice 126 of the spring link 125, which may limit the rotation of the coil spring 110. In an example embodiment, when not at a maximum tension, the first structural insert extension 141 and the first rubber isolator pad extension 131 may freely move within the orifice 126 of the spring link 125. The size of the orifice 126 of the spring link may help limit the maximum degree of rotation of the coil spring 110. In some cases, the coil spring 110 may be limited to 90 degrees of rotation.

In an example embodiment, the second rubber isolator pad extension 132 may be a concave structure that may receive the end of the coil spring 110. The second rubber isolator pad extension 132 may completely surround the end of the coil spring 110. In some cases, the second rubber isolator pad extension 132 may taper the further the second rubber isolator pad extension 132 protrudes from the rubber isolator pad 130. In an example embodiment, the second rubber isolator pad extension 132 may be any structure or shape that may help secure and position the end of the coil spring 110 with the rubber isolator pad 130.

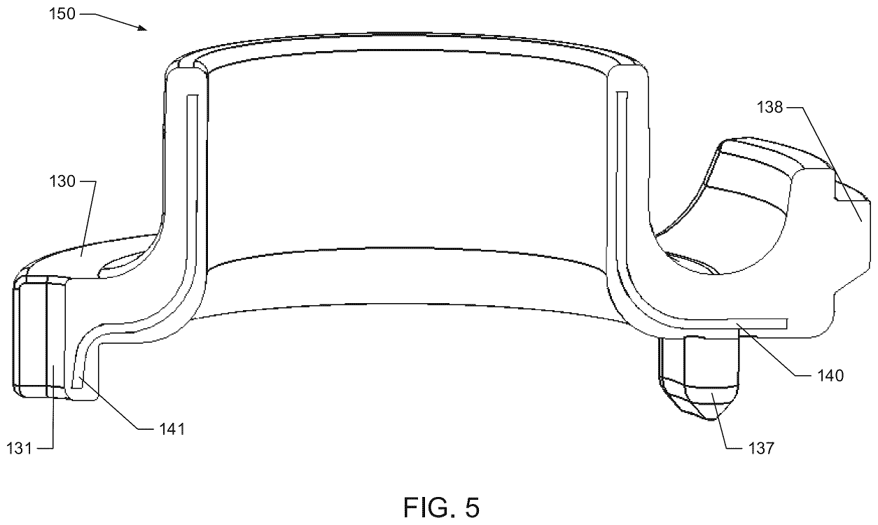

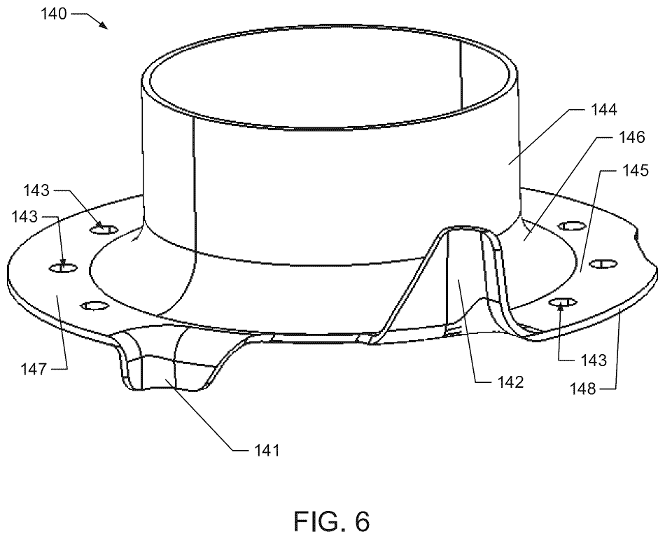

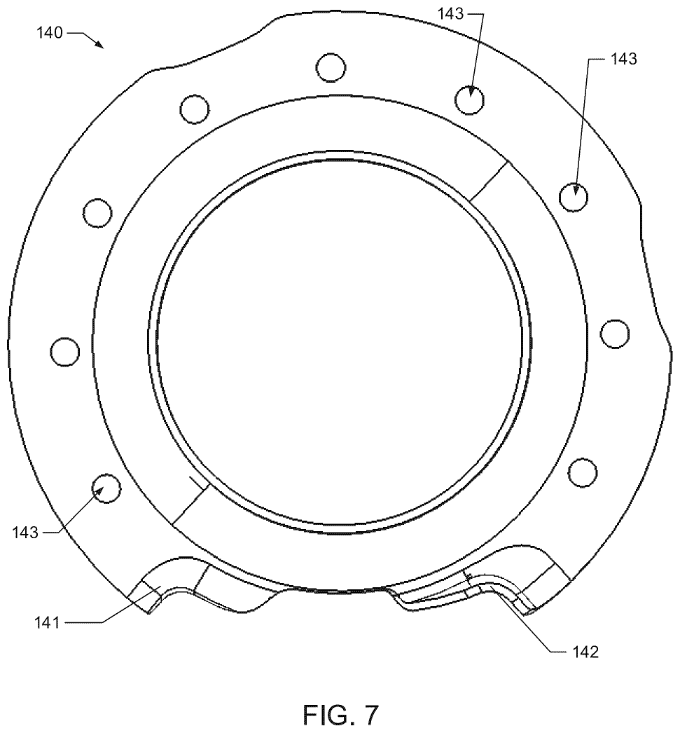

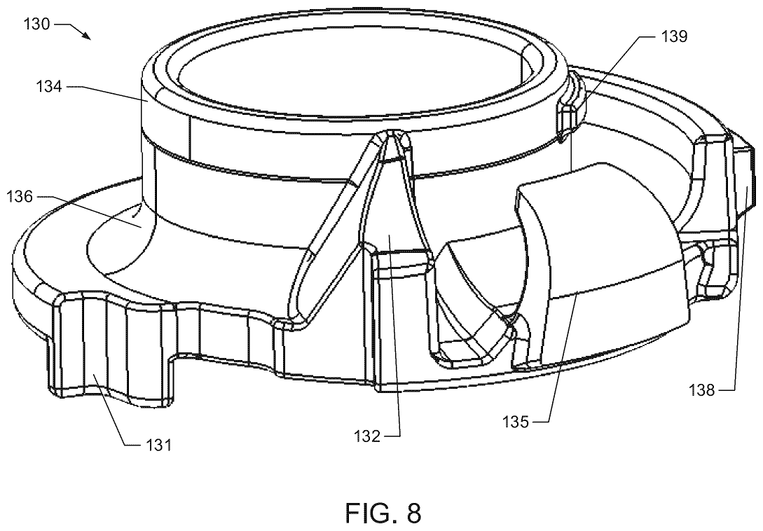

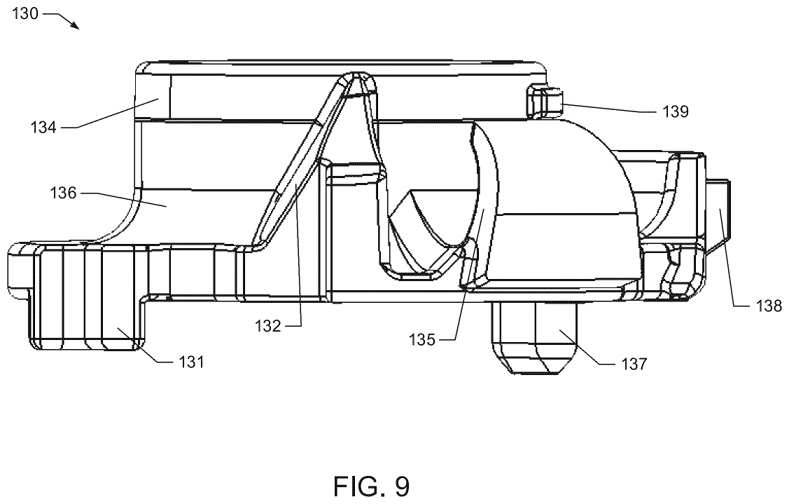

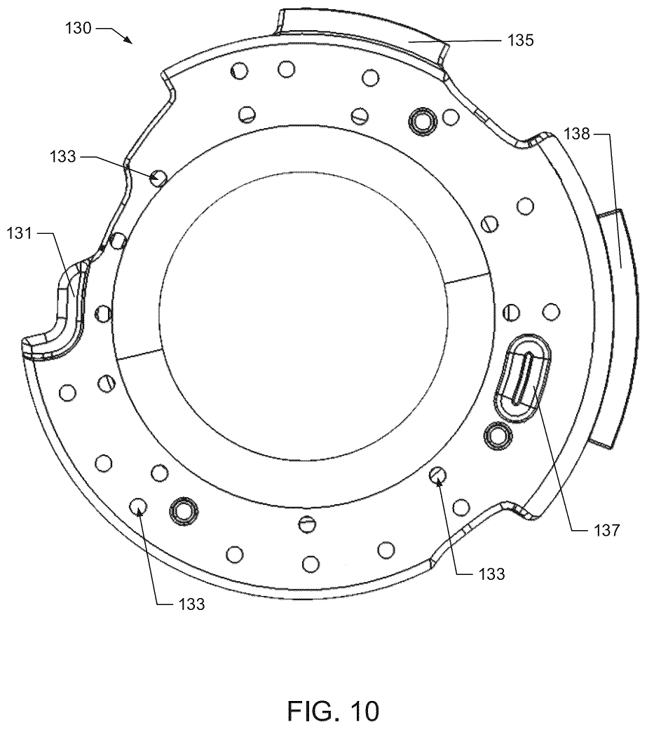

FIGS. 5-10 illustrate different views of the rubber isolator pad 130 and the structural insert 140 alone and in combination with one another. FIG. 5 depicts a cross-section view of the spring isolator pad 150 in accordance with an example embodiment. As shown in FIG. 5, the rubber isolator pad 130 may be supported throughout by the structural insert 140 disposed therein. For example, the first rubber isolator pad extension 131 may be supported by the first structural insert extension 141, and the second rubber isolator pad extension 132 may be supported by the second structural insert extension 142. In some cases, the rubber isolator pad 130 may be made of rubber, polymer, or any other material to ensure an elastomeric property of the rubber isolator pad 130. In an example embodiment, the rubber isolator pad 130 may not be elastomeric and may be any number of materials to ensure performance and durability for the coil spring 110 and the suspension assembly 100 as a whole. In an example embodiment, the rubber isolator pad 130 may serve as a dampener for the suspension assembly 100.

In some cases, the structural insert 140 may be made of aluminum, steel, or any number of metals or metallic materials that may support the rubber isolator pad 130. In an example embodiment, the structural insert 140 may be made of a plastic material or any number of materials that may give the rubber isolator pad 130 greater performance in terms of rigidity and resistance to shear forces. In some cases, the structural insert 140 may not be completely enclosed by the rubber isolator pad 130. For example, the structural insert 140 may be disposed above or below the rubber isolator pad 130 relative to the coil spring 110. Additionally, the spring isolator may have a substantially different structure than the rubber isolator pad 130. The second plurality of extensions of the structural insert 140 may include extensions that may not match with an equivalent extension of the first plurality of extensions of the rubber isolator pad 130.

In an example embodiment, the structural insert 140 may include a guide member 144 to help position the structural insert 140 relative to the coil spring 110. In some cases, the guide member 144 of the structural insert 140 may be cylindrical, circular, rectangular, pentagonal, hexagonal, octagonal, or any number of shapes that may help position the structural insert 140 relative to the coil spring 110. In an example embodiment, the guide member 144 may extend into an interior region of the coil spring 110 when the coil spring 110 is operably coupled to the guide member 144. The guide member may provide additional support to the coil spring 110 and the suspension assembly 100 as a whole.

In some cases, the base 145 of the structural insert 140 may include an outer rim 147. The outer rim 147 and the guide member 144 may be operably coupled via a fillet 146. The fillet 146 may help reduce stress peaks experienced by the structural insert 140 by distributing the stress over a broader area. In an example embodiment, the fillet 146 radius may gradually increase from the guide member 144 to the outer rim 147. In some cases, the fillet 146 may extend completely (360 degrees) around the guide member 144 and define a gradual change in direction from a vertical direction of extension of the guide member 144 to a horizontal direction of extension of the outer rim 147. The fillet 146 may extend and operably couple completely around an interior of the outer rim 147. In an example embodiment, the outer rim 147 may not extend completely around the fillet 146 and the guide member 144. For example, the outer rim 147 may not extend between the first structural insert extension 141 and the second structural insert extension 142.

In some cases, the first structural insert extension 141 and the second structural insert extension 142 may be formed from the outer rim 147. In an example embodiment, the first structural insert extension 141 and the second structural insert extension 142 may have an angled structure. For example, the first structural insert extension 141 and the second structural insert extension 142 may have roughly a 90 degree angled structure. In some cases, the first structural insert extension 141 and second structural insert extension 142 may be flat, rounded, or any number of shapes or structures that may support the rubber isolator pad 130 and the coil spring 110. In an example embodiment, the first structural insert extension 141 and second structural insert extension 142 may be disposed on a radial outer edge 148 of the outer rim 147. In some cases, the first structural insert extension 141 and the second structural insert extension 142 may be disposed on a radial interior edge of the outer rim 147 or on a face of the outer rim 147.

In an example embodiment, a plurality of apertures 143 may be included on a face of the outer rim 147. The plurality of apertures 143 may be mounting apertures for securing the structural insert 140 to elements within the suspension assembly 100. In some cases, the rubber isolator pad 130 may include a matching plurality of apertures 133 that may correspond to the plurality of apertures 143. The rubber isolator pad 130 may include a variety of matching elements to the structural insert 140 in addition, but not limited to, the matching plurality of apertures 133, the first rubber isolator pad extension 131, and the second rubber isolator pad extension 132. For example, the rubber isolator pad 130 may include a matching guide member 134 and a matching fillet 136. Matching elements of the rubber isolator pad 130 may have a similar structure, but may not have an identical shape or structure to the structural insert 140 counterpart elements.

In some cases, the rubber isolator pad 130 may operably couple to the spring link 125 via the first plurality of extensions other than the first rubber isolator pad extension 131. For example, the lower rubber isolator pad extension 137 and the lateral rubber isolator pad extension 138 may operably couple the rubber isolator pad 130 to the spring link 125. In an example embodiment, the first plurality of extension may include any number of extensions that may help increase performance and durability of the suspension assembly 100.

In an example embodiment, the lower rubber isolator pad extension 137 may be disposed at and protrude from a back face of the rubber isolator pad 130. In some cases, the lower rubber isolator pad extension 137 may operably couple the rubber isolator pad 130 and the spring link 125 via insertion into an aperture in the spring link 125. The lower rubber isolator pad extension 137 may be any number of shapes that may help operably couple the rubber isolator pad 130 and the spring link 125.

In some cases, the lateral rubber isolator pad extension 138 may be disposed at and protrude from an outer face of the rubber isolator pad 130. For example, the lateral rubber isolator pad extension 138 may radially extend from an outer face located at a peripheral edge of the rubber isolator pad 130. The lateral rubber isolator pad extension 138 may operably couple the rubber isolator pad 130 and the spring link 125 via the positioning of the lateral rubber isolator pad extensions 138 within a groove, space, slot, or notch in the spring link 125. The lateral rubber isolator pad extension 138 may be any number of shapes that may help operably couple the rubber isolator pad 130 and the spring link 125.

In an example embodiment, the first plurality of extensions of the rubber isolator pad 130 may include a third rubber isolator pad extension 135 and a fourth rubber isolator pad extension 139. The third rubber isolator pad extension 135 and the fourth rubber isolator pad extension 139 may help position the coil spring 110 relative to the rubber isolator pad 130. In some cases, the third rubber isolator pad extension 135 may have a concave structure for receiving a first coil 111 of the coil spring 110 and may be disposed on a base of the rubber isolator pad 130. The third rubber isolator pad extension 135 may enclose approximately 50% or more of the circumference of a first coil 111 of the coil spring 110. The third rubber isolator pad extension 135 may be any number of shapes that may receive the first coil 111 of the coil spring 110 and help position the coil spring 110 with the rubber isolator pad 130.

In an example embodiment, the fourth rubber isolator pad extension 139 may be disposed on the matching guide member 134 of the rubber isolator pad 130. The fourth rubber isolator pad extension 139 may extend radially outward from the matching guide member and may be disposed between the first coil 111 and a second coil 112 of the coil spring 110. The fourth rubber isolator pad extension 139 may help position the coil spring 110 with the rubber isolator pad 130. The fourth rubber isolator pad extension 139 may be any number of shapes or structures that may help in position the coil spring 110 with the rubber isolator pad 130.

In some cases, the structural insert 140 is a unitary piece. In an example embodiment, the rubber isolator pad 130 is a unitary piece. In some cases, the rubber isolator pad 130 may be over-molded on the structural insert 140. The rubber isolator pad 130 and the structural insert 140 may be manufactured via any number of methods that may produce a durable and consistent product.

A spring isolator pad for a suspension assembly for a vehicle may therefore be provided. The spring isolator pad may include a rubber isolator pad for supporting a coil spring operably coupled to a control arm, and a structural insert for supporting a coil spring and the rubber isolator pad. The rubber isolator pad may be operably coupled to the structural insert and comprises a first plurality of extensions. The structural insert may include a second plurality of extensions and a base. The control arm may include a spring link with an orifice. The structural insert may engage with the rubber isolator pad and the spring link to limit rotation of the coil spring relative to the control arm responsive to compression cycles via the first plurality of extensions and the second plurality of extensions.

The spring isolator pad of the suspension assembly of some embodiments may include additional features, modifications, augmentations and/or the like to achieve further objectives or enhance performance of the suspension assembly. The additional features, modifications, augmentations and/or the like may be added in any combination with each other. Below is a list of various additional features, modifications, and augmentations that can each be added individually or in any combination with each other. For example, the second plurality of extensions may include a first structural insert extension and a second structural insert extension. The first structural insert extension may protrude from a base of the structural insert parallel to a longitudinal axis of the coil spring in a first direction away from the coil spring, and the second structural insert extension may protrude from a base of the structural insert parallel to the longitudinal axis of the coil spring in a second direction towards the coil spring. In an example embodiment, the first plurality of extensions may include a first rubber isolator pad extension and a second rubber isolator pad extension. The first rubber isolator pad extension may protrude from the rubber isolator pad in the first direction, and the second rubber isolator pad extension may protrude for the rubber isolator pad in the second direction. In some cases, the first structural insert extension and the first rubber isolator pad extension may engage the orifice of the spring link, and the second structural insert extension and the second rubber isolator pad extension may engage an end of the coil spring. In an example embodiment, the first structural insert extension and the first rubber isolator pad extension may have free movement within the orifice of the spring link. In some cases, the structural insert may be completely enclosed inside the rubber isolator pad. In an example embodiment, the structural insert may include a guide member, wherein the guide member may be cylindrical and may extend into an interior region of the coil spring. In some cases, the base of the structural insert may include an outer rim with a plurality of apertures, and the outer rim and the guide member may be operably coupled via a fillet that may extends 360 degrees around the guide member. In an example embodiment, the first structural insert extension and the second structural insert extension may be disposed at an outer edge of the outer rim of the structural insert. In some cases, the structural insert may limit the coil spring from rotating over 90 degrees from an initial position during operation of the vehicle.

A suspension assembly for a vehicle of an example embodiment may therefore be provided. The suspension assembly may include a coil spring disposed below a chassis of the vehicle, a control arm operably coupled to the coil spring and a wheel of the vehicle, a rubber isolator pad for supporting the coil spring; and a structural insert for supporting the coil spring and rubber isolator pad. The control arm may include a spring link with an orifice. The rubber isolator pad may be disposed on the structural insert and include a first plurality of extensions. The structural insert may include a second plurality of extensions and a base. The structural insert may engage with the rubber isolator pad and the spring link to limit rotation of the coil spring relative to the control arm responsive to compression cycles via the first plurality of extensions and the second plurality of extensions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A spring isolator pad for a suspension assembly for a vehicle, the spring isolator pad comprising:
a rubber isolator pad for supporting a coil spring operably coupled to a control arm; and
a structural insert for supporting a coil spring and the rubber isolator pad,
wherein the rubber isolator pad is operably coupled to the structural insert and comprises a first plurality of extensions,
wherein the structural insert comprises a second plurality of extensions and a base,
wherein the control arm comprises a spring link with an orifice,
wherein the structural insert engages with the rubber isolator pad and the spring link to limit rotation of the coil spring relative to the control arm responsive to compression cycles via the first plurality of extensions and the second plurality of extensions.

2. The spring isolator pad of claim 1, wherein the second plurality of extensions comprise a first structural insert extension and a second structural insert extension,
wherein the first structural insert extension protrudes from the base of the structural insert parallel to a longitudinal axis of the coil spring in a first direction away from the coil spring, and
wherein the second structural insert extension protrudes from the base of the structural insert parallel to the longitudinal axis of the coil spring in a second direction towards the coil spring.

3. The spring isolator pad of claim 2, wherein the first plurality of extensions comprises a first rubber isolator pad extension and a second rubber isolator pad extension,
wherein the first rubber isolator pad extension protrudes from the rubber isolator pad in the first direction, and
wherein the second rubber isolator pad extension protrudes for the rubber isolator pad in the second direction.

4. The spring isolator pad of claim 3, wherein the first structural insert extension and the first rubber isolator pad extension engage the orifice of the spring link, and
wherein the second structural insert extension and the second rubber isolator pad extension engage an end of the coil spring.

5. The spring isolator pad of claim 4, wherein the first structural insert extension and the first rubber isolator pad extension have free movement within the orifice of the spring link.

6. The spring isolator pad of claim 1, wherein the structural insert is completely enclosed inside the rubber isolator pad.

7. The spring isolator pad of claim 1, wherein the structural insert comprises a guide member, wherein the guide member is cylindrical and extends into an interior region of the coil spring.

8. The spring isolator pad of claim 7, wherein the base of the structural insert comprises an outer rim with a plurality of apertures, wherein the outer rim and the guide member are operably coupled via a fillet that extends 360 degrees around the guide member.

9. The spring isolator pad of claim 8, wherein the first structural insert extension and the second structural insert extension are disposed at an outer edge of the outer rim of the structural insert.

10. The spring isolator pad of claim 1, wherein the structural insert limits the coil spring from rotating over 90 degrees from an initial position during operation of the vehicle.

11. A suspension assembly for a vehicle comprising:
a coil spring disposed below a chassis of the vehicle;
a control arm operably coupled to the coil spring and a wheel of the vehicle;
a rubber isolator pad for supporting the coil spring; and
a structural insert for supporting the coil spring and the rubber isolator pad,
wherein the control arm comprises a spring link with an orifice,
wherein the rubber isolator pad is operably coupled to the structural insert and comprises a first plurality of extensions,
wherein the structural insert comprises a second plurality of extensions and a base, and
wherein the structural insert engages with the rubber isolator pad and the spring link to limit rotation of the coil spring relative to the control arm responsive to compression cycles via the first plurality of extensions and the second plurality of extensions.

12. The suspension assembly of claim 11, wherein the second plurality of extensions comprise a first structural insert extension and a second structural insert extension,
wherein the first structural insert extension protrudes from the base of the structural insert parallel to a longitudinal axis of the coil spring in a first direction away from the coil spring, and
wherein the second structural insert extension protrudes from the base of the structural insert parallel to the longitudinal axis of the coil spring in a second direction towards the coil spring.

13. The suspension assembly of claim 12, wherein the first plurality of extensions comprises a first rubber isolator pad extension and a second rubber isolator pad extension,
wherein the first rubber isolator pad extension protrudes from the rubber isolator pad in the first direction, and
wherein the second rubber isolator pad extension protrudes for the rubber isolator pad in the second direction.

14. The suspension assembly of claim 13, wherein the first structural insert extension and the first rubber isolator pad extension engage the orifice of the spring link, and
wherein the second structural insert extension and the second rubber isolator pad extension engage an end of the coil spring.

15. The suspension assembly of claim 14, wherein the first structural insert extension and the first rubber isolator pad extension have free movement within the orifice of the spring link.

16. The suspension assembly of claim 11, wherein the structural insert is completely enclosed inside the rubber isolator pad.

17. The suspension assembly of claim 11, wherein the structural insert comprises a guide member, wherein the guide member is cylindrical and extends into an interior region of the coil spring.

18. The suspension assembly of claim 17, wherein the base of the structural insert comprises an outer rim with a plurality of apertures, wherein the outer rim and the guide member are operably coupled via a fillet that extends 360 degrees around the guide member.

19. The suspension assembly of claim 18, wherein the first structural insert extension and the second structural insert extension are disposed at an outer edge of the outer rim of the structural insert.

20. The suspension assembly of claim 11, wherein the structural insert limits the coil spring from rotating over 90 degrees from an initial position during operation of the vehicle.
